(19) United States
(12) Patent Application Publication
(10) Pub. No.: US 2024/0146748 A1
(43) Pub. Date: May 2, 2024

(54) MALWARE IDENTITY IDENTIFICATION

(71) Applicant: Rubrik, Inc., Palo Alto, CA (US)

(72) Inventors: Muraliraja Muniraju, Fremont, CA (US); Jonathan Xu, Santa Clara, CA (US); Chet Koziol, San Francisco, CA (US); Andrew Cui, San Jose, CA (US)

(21) Appl. No.: 17/979,673

(22) Filed: Nov. 2, 2022

(51) Int. Cl. H04L 9/40; G06F 11/14

(52) U.S. Cl. CPC H04L 63/1425; G06F 11/1464; H04L 63/1416; G06F 2201/84

(57) ABSTRACT

Techniques and configurations for data management are described. Features may be extracted from backup data stored in a data management system for a target object, where the backup data may reflect the target object at a point-in-time. An anomaly associated with the target object may be detected based on the features extracted from the backup data. Based on detecting the anomaly, a malware identity associated with the anomaly may be identified based on the features extracted from the backup data. The identified malware identity may be indicated via a user interface.

### FIELD OF TECHNOLOGY

The present disclosure relates generally to data management, including techniques for malware identity identification.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports malware identity identification in accordance with aspects of the present disclosure.

FIG. 2 illustrates an example of a subsystem that supports malware identity identification in accordance with aspects of the present disclosure.

FIG. 3 illustrates an example of a set of operations that supports malware identity identification in accordance with aspects of the present disclosure.

FIG. 4 illustrates an example of a malware signature repository that supports malware identity identification in accordance with aspects of the present disclosure.

FIG. 5 illustrates an example of a malware identity interface that supports malware identity identification in accordance with aspects of the present disclosure.

FIG. 6 illustrates a block diagram of an apparatus that supports malware identity identification in accordance with aspects of the present disclosure.

FIG. 7 illustrates a block diagram of a data manager that supports malware identity identification in accordance with aspects of the present disclosure.

FIG. 8 illustrates a diagram of a system including a device that supports malware identity identification in accordance with aspects of the present disclosure.

FIG. 9 illustrates a flowchart showing methods that support malware identity identification in accordance with aspects of the present disclosure.

### DETAILED DESCRIPTION

A data management system may take one or more actions based on detecting anomalies in uploaded data (e.g., a backup or snapshot of the data) for a target object—e.g., the data management system may quarantine the uploaded data so that is not available as a recovery point, indicate to the user that an anomaly was detected in the uploaded data, and the like. Based on receiving an indication from the data management system that an anomaly was detected in the uploaded data, a user may begin an investigation of the target object and/or the uploaded data to identify a cause (e.g., malware, unauthorized activity, rare (though authorized) activity, etc.) of the anomaly. In some examples, the indication of the anomaly may include minimal details as to the cause of the anomaly, which may increase an amount of time and effort extended by a user to identify and, in some examples, remediate the cause of the anomaly. Thus, techniques and configurations for including additional information in an anomaly indication regarding the cause of an anomaly may be desired.

To provide additional information of a potential cause of an anomaly detected in uploaded data, a particular malware program expected as causing the anomaly may be identified and indicated to the user. In some examples, in addition to the indication of the malware program, files that are identified as ransom note file candidates, malware-encrypted file candidates, and the like, may be indicated to the user for inspection.

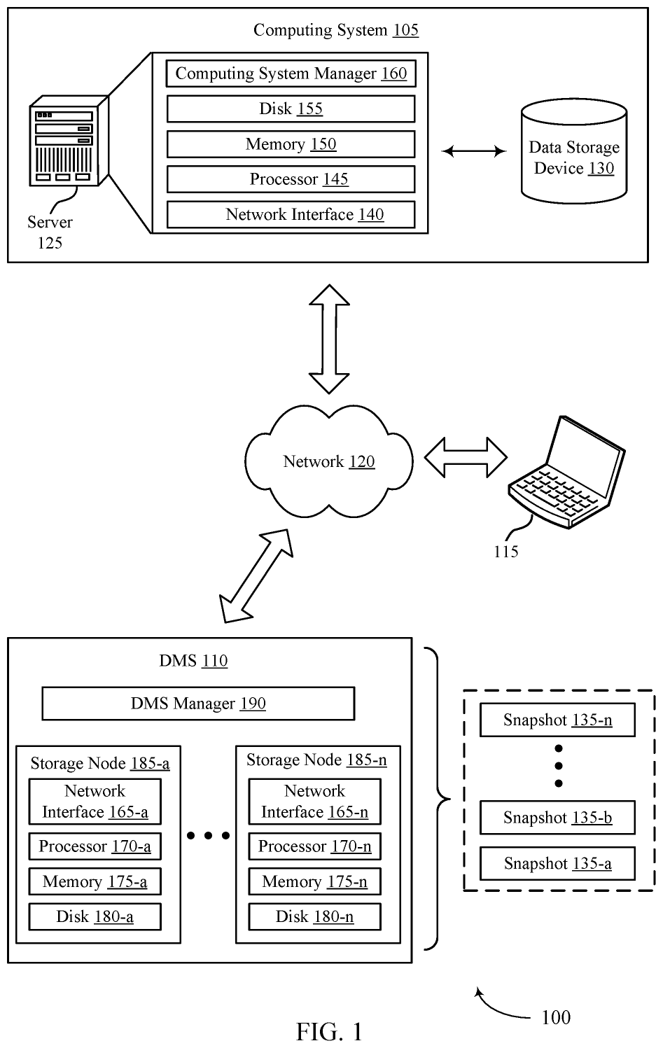

FIG. 1 illustrates an example of a computing environment 100 that supports malware identity identification in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally or alternatively, the DMS 110 may detect whether aspects of the computing system 105 have been impacted by malware (e.g., ransomware). Additionally or alternatively, the DMS 110 may relocate data or create copies of data based on using one or more snapshots 135 to restore the associated computing object within its original location or at a new location (e.g., a new location within a different computing system 105). Additionally or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

As described herein, a user may use the DMS 110 to backup and/or create restore points for data (which may be referred to as backup data or point-in-time data) in the computing system 105. In some examples, data in the computing system 105 may be uploaded to the DMS 110 to create a secondary copy of the data (which may be referred to as a backup of the computing system 105) at a point-in-time, where the secondary copy of the data can be used to fully restore the computing system 105 to the point-in-time in the event of data loss at the computing system 105. Additionally, or alternatively, a state of the data in the computing system 105 (which may be referred to as a snapshot of the computing system 105) may be uploaded to the DMS 110 at a point-in-time, where the stored state of the data may be used to restore the computing system 105 to the point-in-time. The state of the data may be represented by copying, to the DMS 110, a state of a file system and/or metadata for the files at the point-in-time and may exclude a portion (or all) of the content of the data. In some examples, when a stored state of the data is used for restoring the computing system 105, the DMS 110 may be unable to restore the computing system 105 to the point-in-time if the underlying data in the computing system 105 is not stored/lost.

In some examples, the computing system 105 may be or become infected with malware. In some examples, the malware is ransomware that encrypts the files in the computing system 105 and demands that a user pay a fee (“ransom”) for the files to be unencrypted. Additionally, or alternatively, the malware may be used for sabotage, deleting and/or modifying all or portions of the data in the computing system 105. In such cases, if the computing system 105 is or becomes infected, the computing system 105 may upload infected data (e.g., malware program files, encrypted files, etc.) to the DMS 110.

In addition to protecting data for the computing system 105, the DMS 110 may be configured to detect malware activity in the computing system 105. Particularly, the DMS 110 may be configured to identify anomalous behavior in data uploaded by the computing system 105. For example, the DMS 110 may compare data uploaded by the computing system 105 at different times for changes that are indicative of a malware infection (e.g., mass deletions, mass modifications, mass encryption, suspicious file extensions, suspicious file types, suspicious file names, etc.). To compare data uploaded at different times, the DMS 110 may be configured to extract features (e.g., metadata, such as file names, file extensions, file types, etc.) from data that is uploaded by the computing system 105—e.g., during a process which may be referred to as feature extraction. The DMS 110 may then compare features extracted from first uploaded data against features extracted from second uploaded data to identify anomalistic changes that are indicative of malware activity in the computing system 105—e.g., during a process which may be referred to as anomaly detection.

The DMS 110 may take one or more actions based on detecting anomalies in uploaded data (e.g., a backup or snapshot of the data) for the computing system 105—e.g., the DMS 110 may quarantine the uploaded data so that is not available as a recovery point, indicate to the user that an anomaly was detected in the uploaded data, etc. Based on receiving an indication from the DMS 110 that an anomaly was detected in the uploaded data, a user may begin an investigation of the computing system 105 and/or the uploaded data to identify a cause (e.g., malware, unauthorized activity, rare (though authorized) activity, etc.) of the anomaly. In some examples, the indication of the anomaly may include minimal details as to the cause of the anomaly, which may increase an amount of time and effort extended by a user to identify and, in some examples, remediate the cause of the anomaly. Thus, techniques and configurations for including additional information in an anomaly indication regarding the cause of an anomaly may be desired.

To provide additional information of a potential cause of an anomaly detected in uploaded data, a particular malware program (which may also be referred to as a malware strain) expected as causing the anomaly may be identified and indicated to the user. In some examples, in addition to the indication of the malware program, files that are identified as ransom note file candidates, malware-encrypted file candidates, and the like, may be indicated to the user for inspection.

In some examples, the DMS 110 extracts features (e.g., file metadata, file type, file names, encryption status, etc.) from data that is stored in (or being uploaded to) the DMS 110 for the computing system 105, where the data may reflect the target object at a point-in-time. In some examples, the data is a snapshot or a backup of the target object taken the point-int-time. Based on extracting the features from the data, the DMS 110 may detect an anomaly in the data based on the extracted features—e.g., based on detecting changes in the metadata of the uploaded data relative to metadata of previously uploaded data, detecting suspicious file names and/or file types, encrypted files, etc. As a result of detecting the anomaly, the DMS 110 may use the extracted features to identify a malware identity (e.g., a hypothesized malware identity) that caused the anomaly and may indicate the identified malware identity via a user interface.

In some examples, malware identity information is determined for the extracted features as part of the procedure for extracting features from the data. For example, as the features are extracted from the data, the features may be compared with malware signatures stored in a malware signature repository (which may also be referred to as a strain signature repository). For a feature that matches one or more malware signatures, the feature may be updated with malware identity information that indicates that the feature is a suspicious feature and that the feature is associated with one or more malware identities corresponding to the one or more malware signatures. After updating the feature with malware identity information, the feature may be referred to as an augmented feature. The DMS 110 may use the augmented features to identify the malware identity that caused the anomaly.

By identifying and indicating a hypothesized malware identity as causing an anomaly in data uploaded for a computer system, a computer forensics expert may more quickly confirm (and dismiss false positives), identify, and remediate a malware infection in the computer system.

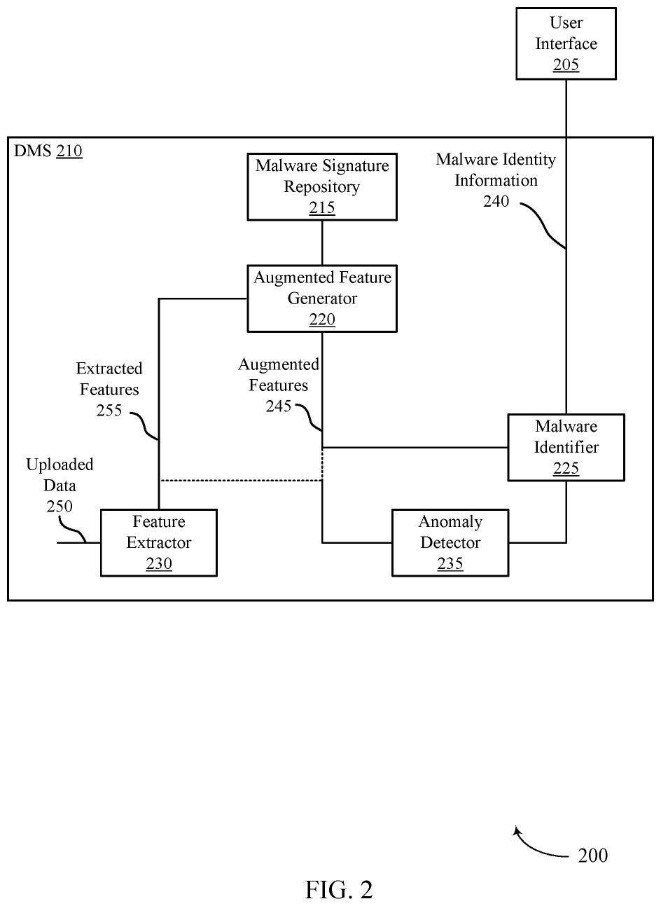

FIG. 2 illustrates an example of a subsystem that supports malware identity identification in accordance with aspects of the present disclosure.

The subsystem 200 may include the user interface 205 and the DMS 210. The user interface may be an example of a user interface displayed on the computing device 115 or at a terminal of the computing system 105 described with reference to FIG. 1. The user interface 205 may be configured to display malware identity information for an anomaly detected in point-in-time data (e.g., a backup or a snapshot) for a target object. For example, the user interface 205 may be configured to display a malware identity that is believed as causing the anomaly, suspicious files that are believed to be ransom notes, suspicious files that are believed to be ransom notes that are believed to be encrypted, or any combination thereof. A customer (e.g., a computer forensics expert) may use the malware identity information displayed on the user interface 205 to identify the particular malware program (e.g., RYUK, Maze, Defray777, WasteLocker, GranCrab+REvil, NetWalker, DoppelPaymer, Dharma, Phobos, Zeppelin, Conti V2, Mespinoza, Sodinokibi, Lockbit 2.0, Hello Kitty, Zeppelin, Ranzy Locker, Suncrypt, Hive, BlackMatter, etc.) affecting the point-in-time data/target object.

The DMS 210 may be an example of the DMS 110 described with reference to FIG. 1. The DMS 210 may be configured to extract augmented features from point-in-time data stored at or uploaded to the DM S210, where the augmented features may include malware identity information. The DMS 210 may be further configured to detect an anomaly (that is indicative of malware, ransomware, unauthorized behavior, etc.) in the point-in-time data and identify a malware identity associated with the anomaly. And the DMS 210 may be configured to indicate malware identity information (e.g., the malware identity, malware-related files, etc.) via the user interface 205. The DMS 210 may include the malware signature repository 215 (which may also be referred to as a strain signature repository), the augmented feature generator 220, the malware identifier 225, the feature extractor 230, and the anomaly detector 235.

The feature extractor 230 may be configured to extract features from point-in-time data, which may be referred to as uploaded data 250. For example, the feature extractor 230 may be configured to extract file names, file extensions, and file types from the point-in-time date. Additionally, or alternatively, the feature extractor 230 may be configured to extract an encryption state of files or data portions (e.g., volumes, partitions, etc.)—e.g., by analyzing the content. Additionally, or alternatively, the feature extractor 230 may be configured to extract metadata for the extracted files (e.g., data created, date modified, etc.). The feature extractor 230 may be configured to output the features extracted from the point-in-time data as extracted features 255.

The augmented feature generator 220 may be configured to augment the features extracted by the feature extractor 230 with malware identity information. The augmented feature generator 220 may be configured to compare the extracted features with malware signatures stored in the malware signature repository 215, where each malware signature may be associated with a particular malware program. Based on matching an extracted feature with a malware signature, the augmented feature generator 220 may identify the feature as a suspicious feature and augment the extracted feature to include malware identity information. That is, the augmented feature generator 220 may update the extracted feature to include an indication that the extracted feature is associated with a malware identity corresponding to the matched malware signature. In some examples, an extracted feature may be associated with multiple malware identities based on matching multiple malware signatures. In some examples, multiple malware identity candidates are indicated across the augmented features 245. The augmented feature generator 220 may be configured to output the augmented extracted features as augmented features 245.

In some cases, the augmented feature generation occurs as part of the feature extraction (e.g., the augmented feature generator 220 may be included in the feature extractor 230), where the extracted features are augmented with malware identity information as the features are extracted. Augmenting the features with malware identity information during extraction may increase an efficiency and speed associated with identifying a malware identity for an anomaly—e.g., relative to comparing the features with the malware signatures after detecting an anomaly.

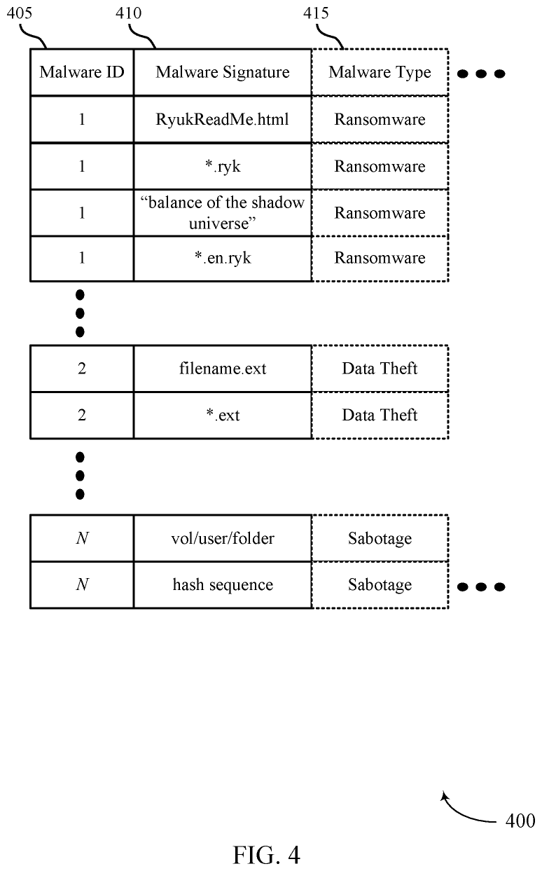

The malware signature repository 215 may be configured to store signatures (e.g., hash results, suspicious file names/extensions, etc.) that are indicative of an infection by a particular malware program. For example, one or more signatures may be indicative of an infection by the RYUK malware program—e.g., a signature may include a particular file extension (.ryk), an encryption pattern, a hash result, etc. The malware signature repository 215, including the structure of data stored in the malware signature repository 215, is described in more detail herein and with reference to FIG. 4. In some examples, the malware signature repository 215 may be configured to receive and store user-defined signatures that are used for user-specific target objects.

The anomaly detector 235 may be configured to use the extracted features (and/or the augmented features) to detect anomalies in point-in-time data. In some examples, the anomaly detector 235 may be configured to perform the anomaly detection using the extracted features 255. Additionally, or alternatively, the anomaly detector 235 may be configured to perform the anomaly detection using the augmented features 245. To detect an anomaly, the anomaly detector 235 may compare the (augmented) features extracted from the point-in-time data with (augmented) features extracted from earlier point-in-time data stored for the target object. In some examples, the anomaly detector 235 may be configured to detect an anomaly for the point-in-time data based on detecting that a threshold quantity of files and/or filenames have been modified, deleted, or encrypted relative to the earlier point-in-time date, that particular metadata (e.g., date created) has been modified for a threshold quantity of files, that a particular file extension is included in the point-in-time data, or the like.

The malware identifier 225 may be configured to determine (e.g., hypothesize) a malware identity associated with the anomaly—e.g., after the anomaly detector 235 detects an anomaly in the point-in-time data. The malware identifier 225 may be configured to determine the malware identity based on the malware identity information included in the augmented features 245. In some examples, the malware identifier 225 determines the malware identity by counting a quantity of times each malware identity in the malware signature repository 215 occurs across the augmented features. In such cases, the malware identifier 225 may select the malware identity as the malware identity that occurs the highest quantity of times across the augmented features. Additionally, or alternatively, the malware identifier 225 may determine the malware identity based on the type of anomaly detected and the malware identities indicated by the augmented features (e.g., if one of the indicated malware identities is most likely associated with the anomaly). Additionally, or alternatively, the malware identifier 225 may input the augmented features into a machine learning model that is trained using data sets infected by different malware programs and processing the suspicious features and associated malware identities to determine a most likely malware identity. The malware identifier 225 may be configured to output a malware identity determined for the anomaly/point-in-time data to the user interface 205.

Based on the determined malware identity, the malware identifier 225 may be further configured to identify one or more sets of files that are expected to be helpful in determining/confirming the malware identity associated with the anomaly. For example, the malware identifier 225 may identify a set of files as ransom note candidates (e.g., based on a known file name for ransom notes issued by the identified malware program, based on a content or structure of the ransom note candidates, etc.). The malware identifier 225 may also identity a set of files as encrypted file candidate (e.g., based on a known file extension for the identified malware program, based on the content and pattern of the files, etc.). The malware identifier 225 may be configured to send the malware-related filed along with the malware identity to the user interface 205, where a customer (e.g., computer forensics expert) may view and analyze the files to identify/confirm the malware identity indicated by the malware identifier.

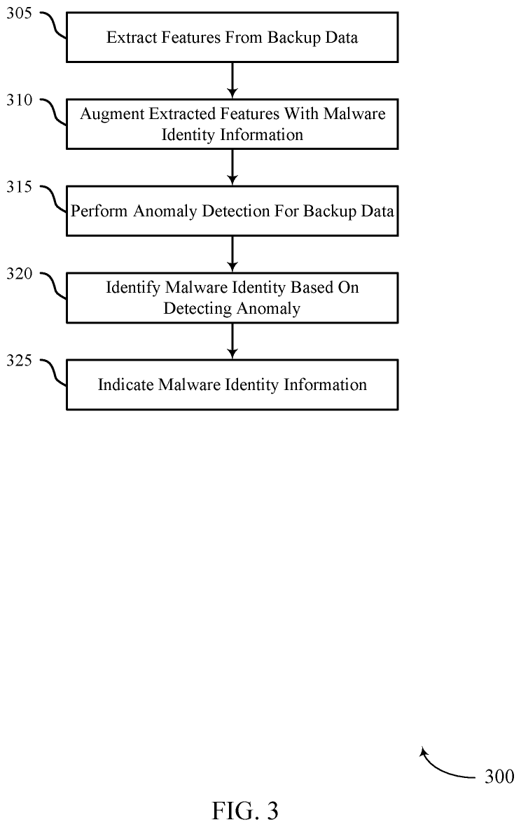

FIG. 3 illustrates an example of a set of operations for malware identity identification in accordance with aspects of the present disclosure.

The process flow 300 may be performed by a DMS, which may be an example of a DMS described herein. In some examples, the process flow 300 illustrates an example set of operations performed to support malware identity identification. For example, the process flow 300 may include operations for augmenting features extracted from backup data with malware identity information and using the augmented features to identify a malware identity associated with an anomaly detected in the backup data.

Aspects of the process flow 300 may be implemented by a controller, among other components. Additionally, or alternatively, aspects of the process flow 300 may be implemented as instructions stored in memory (e.g., firmware stored in a memory coupled with a controller). For example, the instructions, when executed by a controller, may cause the controller to perform the operations of the process flow 300.

One or more of the operations described in the process flow 300 may be performed earlier or later, omitted, replaced, supplemented, or combined with another operation. Also, additional operations described herein may replace, supplement or be combined with one or more of the operations described in the process flow 300.

At 305, features may be extracted (e.g., by a feature extractor, such as the feature extractor 230 of FIG. 2) the from backup data for a target object that is stored at or being uploaded to the data management system. The backup data may correspond to point-in-time data (e.g., a snapshot or a backup) for a target object The features extracted from the backup data may include file names, file extensions, and file types. The features extracted from the backup data may also include an encryption state of files or data sections (e.g., volumes, partitions, etc.). In some examples, the encryption state of files or data sections is determined based on analyzing the content of the files or data sections (or a differential content of the files or data section relative to a prior version) for a data pattern that is indicative of encryption. The features extracted from the backup data (e.g., creation date, modification date, type, size, etc.) may also include metadata for files or data sections.

At 310, the features extracted from the backup data may be augmented (e.g., by an augmented feature generator, such as the augmented feature generator 220 of FIG. 2) with malware identity information. Augmenting the features with malware identity information may include comparing the extracted features with malware signatures that are stored in a malware signature repository (e.g., a malware signature repository, such as the malware signature repository 215), where the malware signatures may correspond to a particular malware identity. In some examples, the malware signatures are stored in malware signature repository in accordance with or similarly as described in FIG. 4.

Based on the comparison, one or more features may match one or more malware signatures. In some examples, one feature may match one or more malware signatures. Based on a match, the one or more features may be augmented to include malware identity information corresponding to the matched malware signatures. For example, a feature that matches a malware signature corresponding to a first malware identity may be augmented to include an indication that the feature is associated with the first malware identity. For example, with reference to FIG. 4, the feature may be a filename that matches “RyukReadMe.html,” which may correspond to the first malware identity (which may correspond to the RYUK malware program). In another example, the feature may be text in a document that matches the string “balance of the shadow universe” (and/or other common text from existing ransom notes), a bitcoin wallet pattern, a TOR web address, or the like. In some examples, the feature may match a second malware signature corresponding to a second malware identity and may be augmented to also include the indication that the feature is associated with the second malware identity.

In some examples, the extracted features are augmented with malware identity information as part of the feature extraction process. For example, as each feature is extracted, the extracted feature may be compared with the malware signature repository prior to the extraction of the next feature. Additionally, or alternatively, the extracted features may be augmented with malware identity information prior to an anomaly detection procedure. For example, after feature extraction but before anomaly detection, each feature may be compared with the malware signature repository. In some examples, the extracted features may be augmented with malware identity information in parallel to an anomaly detection procedure. For example, each feature may be compared with the malware signature repository while the anomaly detection procedure is performed.

In alternative examples, the extracted features may be augmented with malware identity information after the anomaly detection procedure. For example, each feature may be augmented with malware identity information after an anomaly is detected in the corresponding backup data. In some examples, augmenting the extracted feature with malware identity information as part of the feature extraction process is more efficient than comparing the extracted features with the malware signature repository after each feature has been extracted.

At 315, anomaly detection for the backup data may be performed (e.g., by an anomaly detector, such as the anomaly detector 235 of FIG. 2) based on the extracted features. The anomaly detection procedure may include comparing the features extracted from the backup data with features previously extracted from other backup data for the target object. Based on the comparing, the anomaly detection procedure may detect an anomaly such as a mass deletion of data, a mass modification of data, mass encryption of data, modification of metadata that is typically unchanged, etc.

In some examples, the anomaly detection is performed using the augmented features—e.g., if the feature augmenting is performed as part of the feature extraction and/or before the anomaly detection. In other examples, the anomaly detection may be performed using the extracted features—e.g., if the feature augmenting is performed in parallel with the anomaly detection an/d or as a result of an anomaly being detected.

At 320, a malware identity associated with the target object and the backup data may be identified (e.g., by a malware identifier, such as the malware identifier 225 of FIG. 2) the malware based on an anomaly associated with the target object being detected in the extracted features, where the malware identity may be determined based on the augmented features.

One option for identifying the malware identity is to count the quantity of times each malware identity in the malware signature repository occurs across the augmented features and to select the malware identity that occurs the most times. For example, the malware identifier may identify, across the augmented features, a quantity of ransom notes and affected files associated with each malware identity, and e malware identifier may select the malware identity that is associated with the greatest quantity of ransom notes and affected files. In some examples, instead of identifying a single malware identity, the malware identify may identity multiple malware identities—e.g., each of the malware identities for which a threshold quantity of suspicious features are identified.

Additionally, or alternatively, identifying the malware identity may include inputting the augmented features into a machine learning model that has been trained with augmented data sets resulting from respective infections with the malware identities in the malware signature repository. In such cases, the machine learning model may output a most likely malware identity based on the inputted augmented features. In some examples, the identified malware identity may be based on the type of anomaly detected by the anomaly detector (e.g., an encryption anomaly may indicate that the malware is a ransomware type malware).

In some examples, in addition to identifying the malware identity, sets of files that are likely to be helpful for computer forensics activity may also be identified—e.g., based on the malware identity. For example, a set of files may be identified as ransom note candidates. Ransom note candidates may be helpful to a forensics expert as the ransom note may explicitly or implicitly identify the source of the malware. Additionally, or alternatively, a set of files may be identified as malware-encrypted file candidates. Malware-encrypted file candidates may be helpful to a forensics expert to confirm that the files are indeed encrypted, to determine whether the encryption was intentionally performed by the user (e.g., by attempting to decrypt the files using the client password), and the like. Additionally, or alternatively, a set of files may be identified as generally suspicious.

In some examples, the malware-related files may be identified based on file-level attributes (e.g., file names, file extensions, etc.). Additionally, or alternatively, the malware-related files may be identified based on content-level attributes (e.g., embedded text, data patterns, etc.). For example, ransomware notes may be identified based on a particular filename (e.g., “RyukReadMe.html”), a particular file type (e.g., .ryk), a particular file type in a location where a large quantity of changes have been detected, etc.

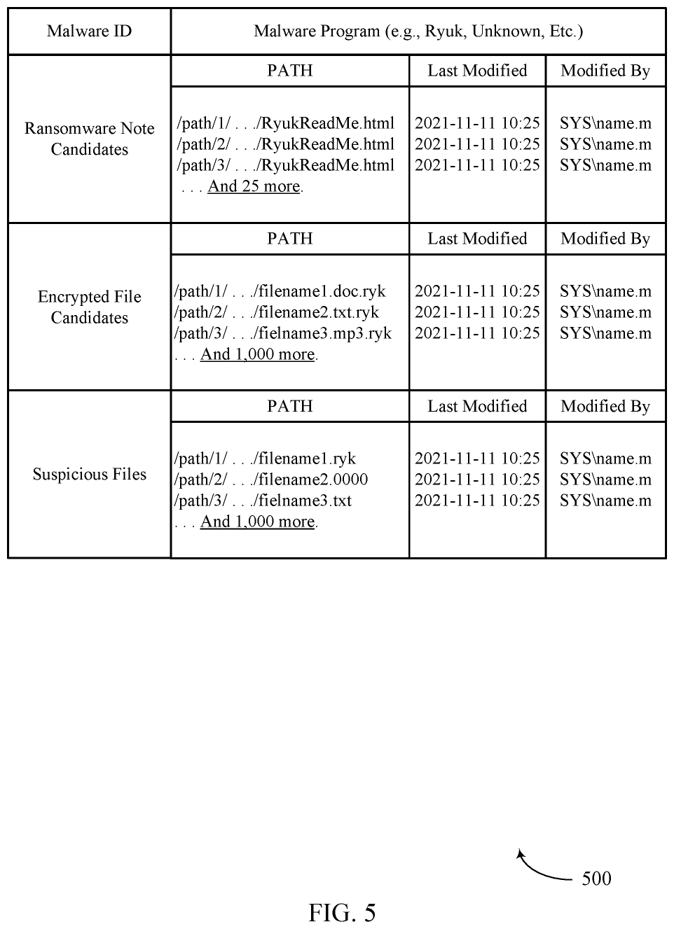

At 325, malware identity information may be indicated (e.g., by the malware identifier) to a user via a user interface (e.g., the user interface 205 of FIG. 2). The malware identity information may include the identified malware identity. In some examples, the malware identity information may include an indication of multiple malware identity candidates—e.g., based on detected a threshold quantity of suspicious features for multiple malware identities. In some examples, the malware identity information may include an indication that no malware identity (e.g., an unknown malware identity) was identified. An example user interface that indicates malware identity information is depicted and described with reference to FIG. 5.

The malware identity information may also include the identified malware-related and suspicious files. In some examples, the user interface displays the malware-related files in a preview environment that allows the user to quickly inspect (e.g., search) the malware-related files. In some examples, the preview environment enables a user to perform sum aggregation (e.g., of particular search terms) across directories and/or to filter the files to include files (e.g., ransomware notes) that include particular search values.

Accordingly, the user may quickly confirm whether the identified malware identity is correct, whether the malware identity was identified as a false positive, and the like. The malware identity information may also include an indication of a quantity of ransomware notes.

In some examples, the malware identity information may include a severity level for the detected anomaly. For example, if the malware identifier determines the malware is a ransomware program, the malware identity information may indicate a critical threat level. And if the malware identifier determines the malware is a non-ransomware program, the malware identity information may indicate a lower threat level.

FIG. 4 illustrates an example of a malware signature repository that supports malware identity identification in accordance with aspects of the present disclosure.

The malware signature repository 400 is configured to store malware signatures for particular malware identities. The malware signature repository 400 may store the malware signatures in a database that includes a malware identity field 405, a malware signature field 410, and a malware type field 415.

The malware identity field 405 may be configured to identify a particular malware program. For example, the malware identity field 405 may include indices that correspond to particular malware programs—e.g., malware ID_1 may correspond to the RYUK malware, malware ID 2 may correspond to the Petya malware, and so on.

The malware signature field 410 may be configured to store a signature for an associated malware program (the program identified by the malware identifier in the same row). For example, the malware signature field 410 may include a file, a file type, a hash sequence, a folder, a YARA rule, a text string, or the like, that has been associated with a malware program—e.g., based on historical infections. For example, the .ryk extension may be associated with the RYUK malware program, which may be of a ransomware type. In some examples, a YARA rule may be created as a malware signature by creating a rule that identifies a suspicious text string (e.g., “encrypted by CONTI ransomware”), where the YARA rule may be associated with the malware ID associated with the CONTI malware program.

The malware type field 415 may be configured to identify a malware type for an associated malware program (the program identified by the malware identifier in the same row). For example, the malware type field 415 may indicate that the associated malware program is a ransomware program, a sabotage program, a data theft program, or the like.

FIG. 5 illustrates an example of a malware identity interface that supports malware identity identification in accordance with aspects of the present disclosure.

The malware identity interface 500 may be displayed at a user interface (e.g., the user interface 205 of FIG. 2). The malware identity interface 500 may include an indication of the identified malware program (e.g., RYUK, Unknown, etc.) associated with a detected anomaly. The malware identity interface 500 may also include an indication of ransomware note candidates, encrypted file candidates, suspicious files, or any combination thereof—e.g., based on a set of identified malware-related and suspicious files. The malware identity interface 500 may further include path information for the malware-related and/or suspicious files, as well as metadata associated with the malware-related and/or suspicious files, such as a last modified date and the user that modified the files, for example.

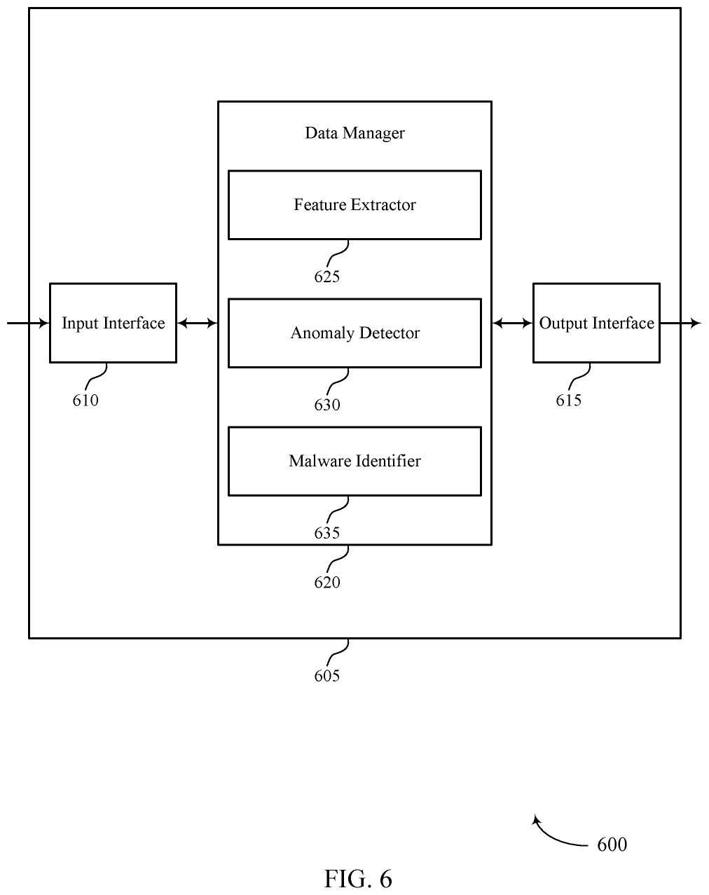

FIG. 6 illustrates a block diagram 600 of a system 605 that supports malware identity identification in accordance with aspects of the present disclosure. In some examples, the system 605 may be an example of aspects of one or more components described with reference to FIG. 1, such as a DMS 110. The system 605 may include an input interface 610, an output interface 615, and a data manager 620. The system 605 may also include one or more processors. Each of these components may be in communication with one another (e.g., via one or more buses, communications links, communications interfaces, or any combination thereof).

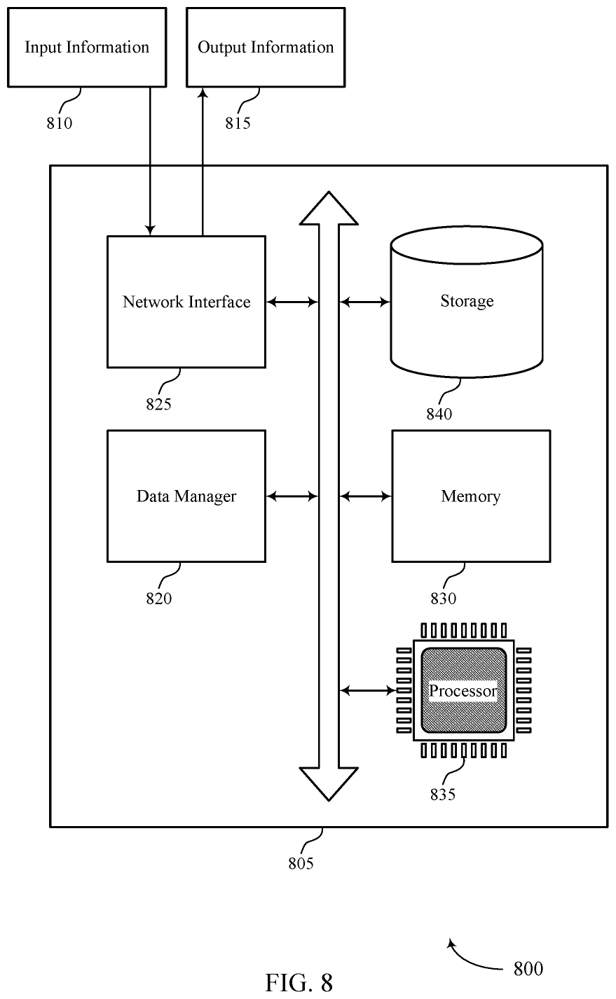

The input interface 610 may manage input signaling for the system 605. For example, the input interface 610 may receive input signaling (e.g., messages, packets, data, instructions, commands, or any other form of encoded information) from other systems or devices. The input interface 610 may send signaling corresponding to (e.g., representative of or otherwise based on) such input signaling to other components of the system 605 for processing. For example, the input interface 610 may transmit such corresponding signaling to the data manager 620 to support malware identity identification. In some cases, the input interface 610 may be a component of a network interface 825 as described with reference to FIG. 8.

The output interface 615 may manage output signaling for the system 605. For example, the output interface 615 may receive signaling from other components of the system 605, such as the data manager 620, and may transmit such output signaling corresponding to (e.g., representative of or otherwise based on) such signaling to other systems or devices. In some cases, the output interface 615 may be a component of a network interface 825 as described with reference to FIG. 8.

The data manager 620 may include a feature extractor 625, an anomaly detector 630, a malware identifier 635, or any combination thereof. In some examples, the data manager 620, or various components thereof, may be configured to perform various operations (e.g., receiving, monitoring, transmitting) using or otherwise in cooperation with the input interface 610, the output interface 615, or both. For example, the data manager 620 may receive information from the input interface 610, send information to the output interface 615, or be integrated in combination with the input interface 610, the output interface 615, or both to receive information, transmit information, or perform various other operations as described herein.

The feature extractor 625 may be configured as or otherwise support a means for extracting, by a data management system, a plurality of features from backup data stored in the data management system for a target object, the backup data reflecting the target object at a point-in-time. The anomaly detector 630 may be configured as or otherwise support a means for detecting, by the data management system an anomaly associated with the target object based at least in part on the plurality of features extracted from the backup data for the target object. The malware identifier 635 may be configured as or otherwise support a means for identifying, by the data management system, as a result of detecting the anomaly and based at least in part on the plurality of features extracted from the backup data, a malware identity associated with the anomaly. The malware identifier 635 may be configured as or otherwise support a means for indicating, by the data management system via a user interface, the identified malware identity.

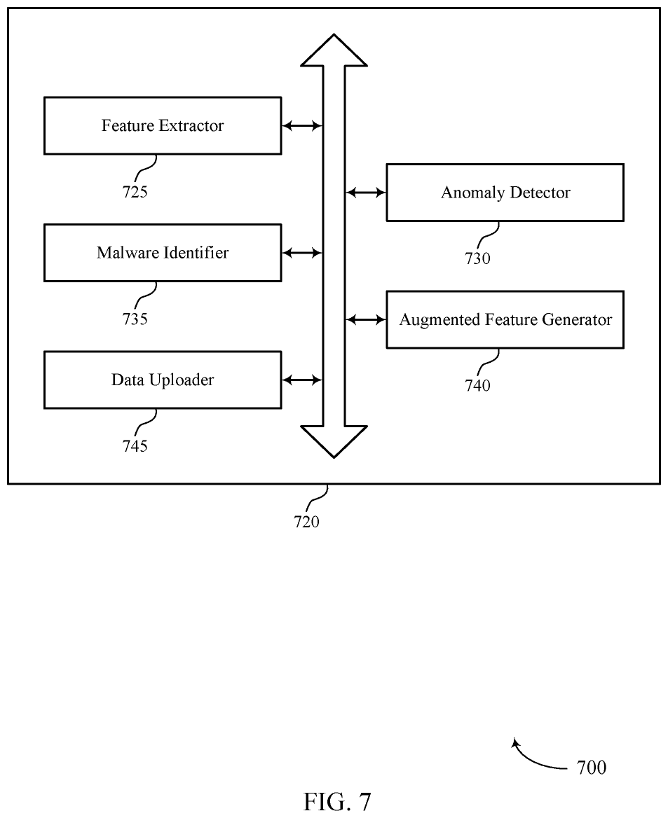

FIG. 7 illustrates a block diagram 700 of a data manager 720 that supports malware identity identification in accordance with aspects of the present disclosure. The data manager 720 may be an example of aspects of a data manager or a data manager 620, or both, as described herein. The data manager 720, or various components thereof, may be an example of means for performing various aspects of malware identity identification as described herein. For example, the data manager 720 may include a feature extractor 725, an anomaly detector 730, a malware identifier 735, an augmented feature generator 740, a data uploader 745, or any combination thereof. Each of these components may communicate, directly or indirectly, with one another (e.g., via one or more buses, communications links, communications interfaces, or any combination thereof).

The feature extractor 725 may be configured as or otherwise support a means for extracting, by a data management system, a plurality of features from backup data stored in the data management system for a target object, the backup data reflecting the target object at a point-in-time. The anomaly detector 730 may be configured as or otherwise support a means for detecting, by the data management system an anomaly associated with the target object based at least in part on the plurality of features extracted from the backup data for the target object. The malware identifier 735 may be configured as or otherwise support a means for identifying, by the data management system, as a result of detecting the anomaly and based at least in part on the plurality of features extracted from the backup data, a malware identity associated with the anomaly. In some examples, the malware identifier 735 may be configured as or otherwise support a means for indicating, by the data management system via a user interface, the identified malware identity.

In some examples, the augmented feature generator 740 may be configured as or otherwise support a means for comparing the plurality of features with a plurality of malware signatures in a malware signature repository, wherein malware signatures of the plurality of malware signatures correspond to respective malware identities.

In some examples, the plurality of features are compared with the plurality of malware signatures before an anomaly detection procedure is performed. In some examples, the anomaly is detected via the anomaly detection procedure.

In some examples, respective features of the plurality of features are compared with the plurality of malware signatures as the respective features are extracted from the backup data.

In some examples, the augmented feature generator 740 may be configured as or otherwise support a means for identifying, based at least in part on the extracting, one or more suspicious features from among the plurality of features based at least in part on correlating the one or more suspicious features with one or more malware signatures of a plurality of malware signatures in a malware signature repository.

In some examples, identifying the one or more suspicious features comprises identifying that a feature included in the plurality of features comprises a filename, a file extension, a content, a hash result, or any combination thereof, that corresponds to a malware signature of the plurality of malware signatures and designating the feature as a suspicious feature based at least in part on identifying that the filename, the file extension, the content, the hash result, or any combination thereof, of the feature corresponds to the malware signature.

In some examples, the augmented feature generator 740 may be configured as or otherwise support a means for associating, based at least in part on extracting the plurality of features, one or more suspicious features included in the plurality of features with one or more malware identities, wherein the one or more malware identities comprise the identified malware identity associated with the anomaly.

In some examples, associating the one or more suspicious features with the one or more malware identities comprises associating a suspicious feature of the one or more suspicious features with a respective malware identity of the one or more malware identities based at least in part on the suspicious feature comprising a filename, a file extension, a content, or any combination thereof, that corresponds to a signature of the respective malware identity.

In some examples, the anomaly detector 730 may be configured as or otherwise support a means for obtaining a plurality of augmented features for the target object based at least in part on the associating, the plurality of augmented features comprising a first portion of the plurality of features that excludes the one or more suspicious features and a second portion of the plurality of features that includes the one or more suspicious features, wherein detecting the anomaly associated with the target object comprises detecting one or more anomalous characteristics of the plurality of augmented features.

In some examples, identifying the malware identity associated with the anomaly comprises inputting the one or more suspicious features to a machine learning model that outputs a hypothesized malware identity based at least in part on the one or more suspicious features, the identified malware identity associated with the anomaly being identified based at least in part on the hypothesized malware identity.

In some examples, identifying the malware identity associated with the anomaly comprises determining respective quantities of the one or more suspicious features, the respective quantities corresponding to respective malware identities of the one or more malware identities. In some examples, the identified malware identity is identified as being associated with the anomaly based at least in part on the identified malware identity corresponding to the largest respective quantity of the respective quantities.

In some examples, the identified malware identity is identified based at least in part on a type of the anomaly.

In some examples, the malware identifier 735 may be configured as or otherwise support a means for identifying, based at least in part on identifying the identified malware identity, a set of suspicious features of the one or more suspicious features that are associated with the identified malware identity. In some examples, the malware identifier 735 may be configured as or otherwise support a means for providing, for inspection via the user interface, one or more files associated with the set of suspicious features, the one or more files being detected as ransom note candidates, as malware-encrypted file candidates, or both.

In some examples, the malware identifier 735 may be configured as or otherwise support a means for identifying, based at least in part on identifying the identified malware identity, a first set of files in the backup data as ransom note candidates, a second set of files in the backup data as malware-encrypted file candidates, or both. In some examples, the malware identifier 735 may be configured as or otherwise support a means for providing, for inspection via the user interface, the first set of files, the second set of files, or both.

In some examples, the data uploader 745 may be configured as or otherwise support a means for storing, prior to extracting the plurality of features from the backup data, the backup data in the data management system.

In some examples, detecting the anomaly associated with the target object comprises comparing the plurality of features extracted from the backup data with a second plurality of features previously extracted from second backup data that reflects the target object at a second point-in-time.

FIG. 8 illustrates a block diagram 800 of a system 805 that supports malware identity identification in accordance with aspects of the present disclosure. The system 805 may be an example of or include the components of a system 605 as described herein. The system 805 may include components for data management, including components such as a data manager 820, a network interface 825, a memory 830, a processor 835, and a storage 840. These components may be in electronic communication or otherwise coupled with each other (e.g., operatively, communicatively, functionally, electronically, electrically; via one or more buses, communications links, communications interfaces, or any combination thereof). Additionally, the components of the system 805 may comprise corresponding physical components or may be implemented as corresponding virtual components (e.g., components of one or more virtual machines). In some examples, the system 805 may be an example of aspects of one or more components described with reference to FIG. 1, such as a DMS 110.

The network interface 825 may enable the system 805 to exchange information (e.g., input information 810, output information 815, or both) with other systems or devices (not shown). For example, the network interface 825 may enable the system 805 to connect to a network (e.g., a network 120 as described herein, including with reference to FIG. 1). The network interface 825 may include one or more wireless network interfaces, one or more wired network interfaces, or any combination thereof. In some examples, the network interface 825 may be an example of may be an example of aspects of one or more components described with reference to FIG. 1, such as one or more network interfaces 165.

Memory 830 may include RAM, ROM, or both. The memory 830 may store computer-readable, computer-executable software including instructions that, when executed, cause the processor 835 to perform various functions described herein. In some cases, the memory 830 may contain, among other things, a basic input/output system (BIOS), which may control basic hardware or software operation such as the interaction with peripheral components or devices. In some cases, the memory 830 may be an example of aspects of one or more components described with reference to FIG. 1, such as one or more memories 175.

The processor 835 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 835 may be configured to execute computer-readable instructions stored in a memory 830 to perform various functions (e.g., functions or tasks supporting malware identity identification). Though a single processor 835 is depicted in the example of FIG. 8, it is to be understood that the system 805 may include any quantity of one or more of processors 835 and that a group of processors 835 may collectively perform one or more functions ascribed herein to a processor, such as the processor 835. In some cases, the processor 835 may be an example of aspects of one or more components described with reference to FIG. 1, such as one or more processors 170.

Storage 840 may be configured to store data that is generated, processed, stored, or otherwise used by the system 805. In some cases, the storage 840 may include one or more HDDs, one or more SDDs, or both. In some examples, the storage 840 may be an example of a single database, a distributed database, multiple distributed databases, a data store, a data lake, or an emergency backup database. In some examples, the storage 840 may be an example of one or more components described with reference to FIG. 1, such as one or more network disks 180.

The data manager 820 may be configured as or otherwise support a means for extracting, by a data management system, a plurality of features from backup data stored in the data management system for a target object, the backup data reflecting the target object at a point-in-time. The data manager 820 may be configured as or otherwise support a means for detecting, by the data management system an anomaly associated with the target object based at least in part on the plurality of features extracted from the backup data for the target object. The data manager 820 may be configured as or otherwise support a means for identifying, by the data management system, as a result of detecting the anomaly and based at least in part on the plurality of features extracted from the backup data, a malware identity associated with the anomaly. The data manager 820 may be configured as or otherwise support a means for indicating, by the data management system via a user interface, the identified malware identity.

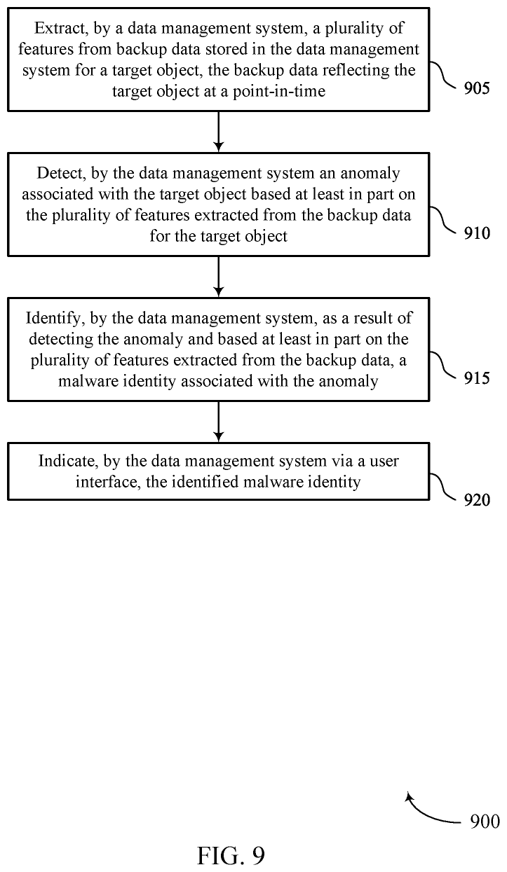

FIG. 9 illustrates a flowchart showing a method 900 that supports malware identity identification in accordance with aspects of the present disclosure. The operations of the method 900 may be implemented by a DMS or its components as described herein. For example, the operations of the method 900 may be performed by a DMS as described with reference to FIGS. 1 through 8. In some examples, a DMS may execute a set of instructions to control the functional elements of the DMS to perform the described functions. Additionally, or alternatively, the DMS may perform aspects of the described functions using special-purpose hardware.

At 905, the method may include extracting, by a data management system, a plurality of features from backup data stored in the data management system for a target object, the backup data reflecting the target object at a point-in-time. The operations of 905 may be performed in accordance with examples as disclosed herein. In some examples, aspects of the operations of 905 may be performed by a feature extractor 725 as described with reference to FIG. 7.

At 910, the method may include detecting, by the data management system an anomaly associated with the target object based at least in part on the plurality of features extracted from the backup data for the target object. The operations of 910 may be performed in accordance with examples as disclosed herein. In some examples, aspects of the operations of 910 may be performed by an anomaly detector 730 as described with reference to FIG. 7.

At 915, the method may include identifying, by the data management system, as a result of detecting the anomaly and based at least in part on the plurality of features extracted from the backup data, a malware identity associated with the anomaly. The operations of 915 may be performed in accordance with examples as disclosed herein. In some examples, aspects of the operations of 915 may be performed by a malware identifier 735 as described with reference to FIG. 7.

At 920, the method may include indicating, by the data management system via a user interface, the identified malware identity. The operations of 920 may be performed in accordance with examples as disclosed herein. In some examples, aspects of the operations of 920 may be performed by a malware identifier 735 as described with reference to FIG. 7.

A method is described. The method may include extracting, by a data management system, a plurality of features from backup data stored in the data management system for a target object, the backup data reflecting the target object at a point-in-time, detecting, by the data management system, an anomaly associated with the target object based at least in part on the plurality of features extracted from the backup data for the target object, identifying, by the data management system, as a result of detecting the anomaly and based at least in part on the plurality of features extracted from the backup data, a malware identity associated with the anomaly, and indicating, by the data management system via a user interface, the identified malware identity.

An apparatus is described. The apparatus may include a processor, memory coupled with the processor, and instructions stored in the memory. The instructions may be executable by the processor to cause the apparatus to extract, by a data management system, a plurality of features from backup data stored in the data management system for a target object, the backup data reflecting the target object at a point-in-time, detect, by the data management system, an anomaly associated with the target object based at least in part on the plurality of features extracted from the backup data for the target object, identify, by the data management system, as a result of detecting the anomaly and based at least in part on the plurality of features extracted from the backup data, a malware identity associated with the anomaly, and indicate, by the data management system via a user interface, the identified malware identity.

Another apparatus is described. The apparatus may include means for extracting, by a data management system, a plurality of features from backup data stored in the data management system for a target object, the backup data reflecting the target object at a point-in-time, means for detecting, by the data management system, an anomaly associated with the target object based at least in part on the plurality of features extracted from the backup data for the target object, means for identifying, by the data management system, as a result of detecting the anomaly and based at least in part on the plurality of features extracted from the backup data, a malware identity associated with the anomaly, and means for indicating, by the data management system via a user interface, the identified malware identity.

A non-transitory computer-readable medium storing code is described. The code may include instructions executable by a processor to extract, by a data management system, a plurality of features from backup data stored in the data management system for a target object, the backup data reflecting the target object at a point-in-time, detect, by the data management system, an anomaly associated with the target object based at least in part on the plurality of features extracted from the backup data for the target object, identify, by the data management system, as a result of detecting the anomaly and based at least in part on the plurality of features extracted from the backup data, a malware identity associated with the anomaly, and indicate, by the data management system via a user interface, the identified malware identity.

Some examples of the method, apparatuses, and non-transitory computer-readable medium described herein may further include operations, features, means, or instructions for comparing the plurality of features with a plurality of malware signatures in a malware signature repository, wherein malware signatures of the plurality of malware signatures correspond to respective malware identities.

In some examples of the method, apparatuses, and non-transitory computer-readable medium described herein, the plurality of features may be compared with the plurality of malware signatures before an anomaly detection procedure may be performed and the anomaly may be detected via the anomaly detection procedure.

In some examples of the method, apparatuses, and non-transitory computer-readable medium described herein, respective features of the plurality of features may be compared with the plurality of malware signatures as the respective features may be extracted from the backup data.

Some examples of the method, apparatuses, and non-transitory computer-readable medium described herein may further include operations, features, means, or instructions for identifying, based at least in part on the extracting, one or more suspicious features from among the plurality of features based at least in part on correlating the one or more suspicious features with one or more malware signatures of a plurality of malware signatures in a malware signature repository.

In some examples of the method, apparatuses, and non-transitory computer-readable medium described herein, operations, features, means, or instructions for identifying the one or more suspicious features may include operations, features, means, or instructions for identifying that a feature included in the plurality of features comprises a filename, a file extension, a content, a hash result, or any combination thereof, that corresponds to a malware signature of the plurality of malware signatures and designating the feature as a suspicious feature based at least in part on identifying that the filename, the file extension, the content, the hash result, or any combination thereof, of the feature corresponds to the malware signature.

Some examples of the method, apparatuses, and non-transitory computer-readable medium described herein may further include operations, features, means, or instructions for associating, based at least in part on extracting the plurality of features, one or more suspicious features included in the plurality of features with one or more malware identities, wherein the one or more malware identities comprise the identified malware identity associated with the anomaly.

In some examples of the method, apparatuses, and non-transitory computer-readable medium described herein, operations, features, means, or instructions for associating the one or more suspicious features with the one or more malware identities may include operations, features, means, or instructions for associating a suspicious feature of the one or more suspicious features with a respective malware identity of the one or more malware identities based at least in part on the suspicious feature comprising a filename, a file extension, a content, or any combination thereof, that corresponds to a signature of the respective malware identity.

Some examples of the method, apparatuses, and non-transitory computer-readable medium described herein may further include operations, features, means, or instructions for obtaining a plurality of augmented features for the target object based at least in part on the associating, the plurality of augmented features comprising a first portion of the plurality of features that excludes the one or more suspicious features and a second portion of the plurality of features that includes the one or more suspicious features, wherein detecting the anomaly associated with the target object comprises detecting one or more anomalous characteristics of the plurality of augmented features.

In some examples of the method, apparatuses, and non-transitory computer-readable medium described herein, operations, features, means, or instructions for identifying the malware identity associated with the anomaly may include operations, features, means, or instructions for inputting the one or more suspicious features to a machine learning model that outputs a hypothesized malware identity based at least in part on the one or more suspicious features, the identified malware identity associated with the anomaly being identified based at least in part on the hypothesized malware identity.

In some examples of the method, apparatuses, and non-transitory computer-readable medium described herein, operations, features, means, or instructions for identifying the malware identity associated with the anomaly may include operations, features, means, or instructions for determining respective quantities of the one or more suspicious features, the respective quantities corresponding to respective malware identities of the one or more malware identities, wherein the identified malware identity may be identified as being associated with the anomaly based at least in part on the identified malware identity corresponding to a largest respective quantity of the respective quantities.

In some examples of the method, apparatuses, and non-transitory computer-readable medium described herein, the identified malware identity may be identified based at least in part on a type of the anomaly.

Some examples of the method, apparatuses, and non-transitory computer-readable medium described herein may further include operations, features, means, or instructions for identifying, based at least in part on identifying the identified malware identity, a set of suspicious features of the one or more suspicious features that may be associated with the identified malware identity and providing, for inspection via the user interface, one or more files associated with the set of suspicious features, the one or more files being detected as ransom note candidates, as malware-encrypted file candidates, or both.

Some examples of the method, apparatuses, and non-transitory computer-readable medium described herein may further include operations, features, means, or instructions for identifying, based at least in part on identifying the identified malware identity, a first set of files in the backup data as ransom note candidates, a second set of files in the backup data as malware-encrypted file candidates, or both, and providing, for inspection via the user interface, the first set of files, the second set of files, or both.

Some examples of the method, apparatuses, and non-transitory computer-readable medium described herein may further include operations, features, means, or instructions for storing, prior to extracting the plurality of features from the backup data, the backup data in the data management system.

In some examples of the method, apparatuses, and non-transitory computer-readable medium described herein, operations, features, means, or instructions for detecting the anomaly associated with the target object may include operations, features, means, or instructions for comparing the plurality of features extracted from the backup data with a second plurality of features previously extracted from second backup data that reflects the target object at a second point-in-time.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
extracting, by a data management system, a plurality of features from backup data stored in the data management system for a target object, the backup data reflecting the target object at a point-in-time;
detecting, by the data management system, an anomaly associated with the target object based at least in part on the plurality of features extracted from the backup data for the target object;
identifying, by the data management system, as a result of detecting the anomaly and based at least in part on the plurality of features extracted from the backup data, a malware identity associated with the anomaly; and
indicating, by the data management system via a user interface, the identified malware identity.

2. The method of claim 1, further comprising:
comparing the plurality of features with a plurality of malware signatures in a malware signature repository, wherein malware signatures of the plurality of malware signatures correspond to respective malware identities.

3. The method of claim 2, wherein:
the plurality of features are compared with the plurality of malware signatures before an anomaly detection procedure is performed, wherein the anomaly is detected via the anomaly detection procedure.

4. The method of claim 2, wherein:
respective features of the plurality of features are compared with the plurality of malware signatures as the respective features are extracted from the backup data.

5. The method of claim 1, further comprising:
identifying, based at least in part on the extracting, one or more suspicious features from among the plurality of features based at least in part on correlating the one or more suspicious features with one or more malware signatures of a plurality of malware signatures in a malware signature repository.

6. The method of claim 5, wherein identifying the one or more suspicious features comprises:
identifying that a feature included in the plurality of features comprises a filename, a file extension, a content, a hash result, or any combination thereof, that corresponds to a malware signature of the plurality of malware signatures; and
designating the feature as a suspicious feature based at least in part on identifying that the filename, the file extension, the content, the hash result, or any combination thereof, of the feature corresponds to the malware signature.

7. The method of claim 1, further comprising:
associating, based at least in part on extracting the plurality of features, one or more suspicious features included in the plurality of features with one or more malware identities, wherein the one or more malware identities comprise the identified malware identity associated with the anomaly.

8. The method of claim 7, wherein associating the one or more suspicious features with the one or more malware identities comprises:
associating a suspicious feature of the one or more suspicious features with a respective malware identity of the one or more malware identities based at least in part on the suspicious feature comprising a filename, a file extension, a content, or any combination thereof, that corresponds to a signature of the respective malware identity.

9. The method of claim 7, further comprising:
obtaining a plurality of augmented features for the target object based at least in part on the associating, the plurality of augmented features comprising a first portion of the plurality of features that excludes the one or more suspicious features and a second portion of the plurality of features that includes the one or more suspicious features,
wherein detecting the anomaly associated with the target object comprises detecting one or more anomalous characteristics of the plurality of augmented features.

10. The method of claim 7, wherein identifying the malware identity associated with the anomaly comprises:
inputting the one or more suspicious features to a machine learning model that outputs a hypothesized malware identity based at least in part on the one or more suspicious features, the identified malware identity associated with the anomaly being identified based at least in part on the hypothesized malware identity.

11. The method of claim 7, wherein identifying the malware identity associated with the anomaly comprises:
determining respective quantities of the one or more suspicious features, the respective quantities corresponding to respective malware identities of the one or more malware identities, wherein the identified malware identity is identified as being associated with the anomaly based at least in part on the identified malware identity corresponding to a largest respective quantity of the respective quantities.

12. The method of claim 7, wherein the identified malware identity is identified based at least in part on a type of the anomaly.

13. The method of claim 11, further comprising:
identifying, based at least in part on identifying the identified malware identity, a set of suspicious features of the one or more suspicious features that are associated with the identified malware identity; and
providing, for inspection via the user interface, one or more files associated with the set of suspicious features, the one or more files being detected as ransom note candidates, as malware-encrypted file candidates, or both.

14. The method of claim 1, further comprising:
identifying, based at least in part on identifying the identified malware identity, a first set of files in the backup data as ransom note candidates, a second set of files in the backup data as malware-encrypted file candidates, or both; and
providing, for inspection via the user interface, the first set of files, the second set of files, or both.

15. The method of claim 1, further comprising:
storing, prior to extracting the plurality of features from the backup data, the backup data in the data management system.

16. The method of claim 1, wherein detecting the anomaly associated with the target object comprises:
comparing the plurality of features extracted from the backup data with a second plurality of features previously extracted from second backup data that reflects the target object at a second point-in-time.

17. An apparatus, comprising:
a processor; and
a memory storing instructions executable by the processor to cause the apparatus to:
extract, by a data management system, a plurality of features from backup data stored in the data management system for a target object, the backup data reflecting the target object at a point-in-time;
detect, by the data management system, an anomaly associated with the target object based at least in part on the plurality of features extracted from the backup data for the target object;
identify, by the data management system, as a result of detecting the anomaly and based at least in part on the plurality of features extracted from the backup data, a malware identity associated with the anomaly; and
indicate, by the data management system via a user interface, the identified malware identity.

18. The apparatus of claim 17, wherein the instructions are further executable by the processor to cause the apparatus to:
compare the plurality of features with a plurality of malware signatures in a malware signature repository, wherein malware signatures of the plurality of malware signatures correspond to respective malware identities.

19. A non-transitory, computer-readable medium storing code that comprises instructions executable by a processor of an electronic device to cause the electronic device to:
extract, by a data management system, a plurality of features from backup data stored in the data management system for a target object, the backup data reflecting the target object at a point-in-time;
detect, by the data management system, an anomaly associated with the target object based at least in part on the plurality of features extracted from the backup data for the target object;
identify, by the data management system, as a result of detecting the anomaly and based at least in part on the plurality of features extracted from the backup data, a malware identity associated with the anomaly; and
indicate, by the data management system via a user interface, the identified malware identity.

20. The non-transitory, computer-readable medium of claim 19, wherein the instructions are further executable by the processor to cause the electronic device to:
compare the plurality of features with a plurality of malware signatures in a malware signature repository, wherein malware signatures of the plurality of malware signatures correspond to respective malware identities.
